(19) United States
(12) Patent Application Publication
(10) Pub. No.: US 2008/0259951 A1
(43) Pub. Date: Oct. 23, 2008

(54) METHOD AND APPARATUS FOR UNPLANNED AND UNINTERRUPTED NETWORK ADAPTER REPLACEMENT

(76) Inventors: OMAR CARDONA, Austin, TX (US); James Brian Cunningham, Austin, TX (US); Baltazar De Leon, Austin, TX (US); Jorge Rafael Nogueras, Austin, TX (US)

Correspondence Address: IBM CORP (YA);C/O YEE & ASSOCIATES PC, P.O. BOX 802333, DALLAS, TX, 75380, US

(21) Appl. No.: 11/738,538

(22) Filed: Apr. 23, 2007

(51) Int. Cl. H04J 3/16

(52) U.S. Cl. 370/465

(57) ABSTRACT

A computer implemented method, data processing system, and computer program product for dynamically replacing a network adapter with minimal or no communications downtime. When a notification to replace a first network adapter is received, the process in the illustrative embodiments detects a replacement network adapter and a network interface corresponding to the replacement network adapter. The process configures a replacement network adapter, and pauses all communications to the first network adapter by dropping all incoming data packets to the first network adapter. The network interface corresponding to the first network adapter is redirected to point to the replacement network adapter. The first network adapter and the network interface corresponding to the replacement network adapter are then removed. Communication flow to the replacement network adapter is restored.

### BACKGROUND OF THE INVENTION

1. Field of the Invention

The present invention relates generally to an improved data processing system, and in particular to a computer implemented method, data processing system, and computer program product for dynamically replacing a network adapter with minimal or no communications downtime.

2. Description of the Related Art

A network adapter is a piece of computer hardware which provides an interface between a computer and a network, such as a local area network (LAN). The network adapter allows computers to communicate over a network by controlling the transmission and receiving of data between the physical level (layer 1 of the Open Systems Interconnection (OSI) model) and the data link level (layer 2 of the OSI model). A media access control (MAC) address is attached to each network adapter and serves as a unique identifier for each adapter.

Network adapters may be replaced when the adapters fail in some way. For example, an adapter may fail completely, wherein no data is transmitted or received by the device, or the adapter may still be operating, but only partially. In these circumstances, the network adapter may be replaced to reestablish or improve the connectivity. One existing technology, Etherchannel, is a network aggregation technology which combines the bandwidth of multiple Ethernet adapters into a single logical link to increase the link speed beyond the limits of any one single cable or port and load balance traffic across those links. Etherchannel (IEEE 802.3ad) provides the capability of dynamically allocating and removing network adapters assigned to an Etherchannel link aggregation group. Implementing Etherchannel technology offers other advantages when removing adapters, including not having to modify the interface presented to the stack, as well as having no interruption in connectivity. However, in order to dynamically allocate and remove network adapters in a live system, Etherchannel and similar methods require planning and configuring multiple adapters under an Etherchannel Link Aggregation group at system deployment time. Thus, while Etherchannel allows for removing an adapter without losing connectivity, Etherchannel requires having a link aggregation group setup prior to removal or de-allocation of an adapter, and consequently requires that the user prepare ahead of time for an adapter replacement by preconfiguring the adapter at system setup time. In addition, Etherchannel does not provide for dynamic replacement of an adapter (i.e., switching a failed adapter with a new adapter), but only provides a failover mechanism that applies the load of the failed adapter to the other adapters in the aggregation group.

In the current art, the process of replacing network adapters is limited to performing multiple combinations of manual steps to remove the network adapter and then add the replacement adapter. The advantages of using these existing manual adapter replacement methods include needing only one network adapter in the system at setup time, implementing standard manual device removal and allocation, and having no requirements on the Ethernet switch. However, these manual adapter replacement methods are prone to operator error, and can exponentially increase connectivity downtime while an adapter is being replaced. For instance, in the manual adapter replacement methods, the operator or administrator will need to stop any critical traffic running over the interface before removing the interface. In addition, interface unconfiguration and adapter/driver state machine closure is required before a HotPlug adapter operation can occur.

### SUMMARY OF THE INVENTION

The illustrative embodiments provide a computer implemented method, data processing system, and computer program product for dynamically replacing a network adapter with minimal or no communications downtime. When a notification to replace a first network adapter is received, the process in the illustrative embodiments detects a replacement network adapter and a network interface corresponding to the replacement network adapter. The process configures a replacement network adapter, and pauses all communications to the first network adapter by dropping all incoming data packets to the first network adapter. The network interface corresponding to the first network adapter is redirected to point to the replacement network adapter. The first network adapter and the network interface corresponding to the replacement network adapter are then removed. Communication flow to the replacement network adapter is restored.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the illustrative embodiments may be implemented;

FIG. 2 is a block diagram of a data processing system in which the illustrative embodiments may be implemented;

FIG. 3 is a block diagram of a network adapter in accordance with the illustrative embodiments;

FIGS. 4A-4F are diagrams which illustrate a network adapter replacement operation in accordance with the illustrative embodiments; and

FIG. 5 is a flowchart of a process for implementing an unplanned replacement of a network adapter with minimal or no communications downtime in accordance with the illustrative embodiments.

### DETAILED DESCRIPTION OF THE PREFERRED EMBODIMENT

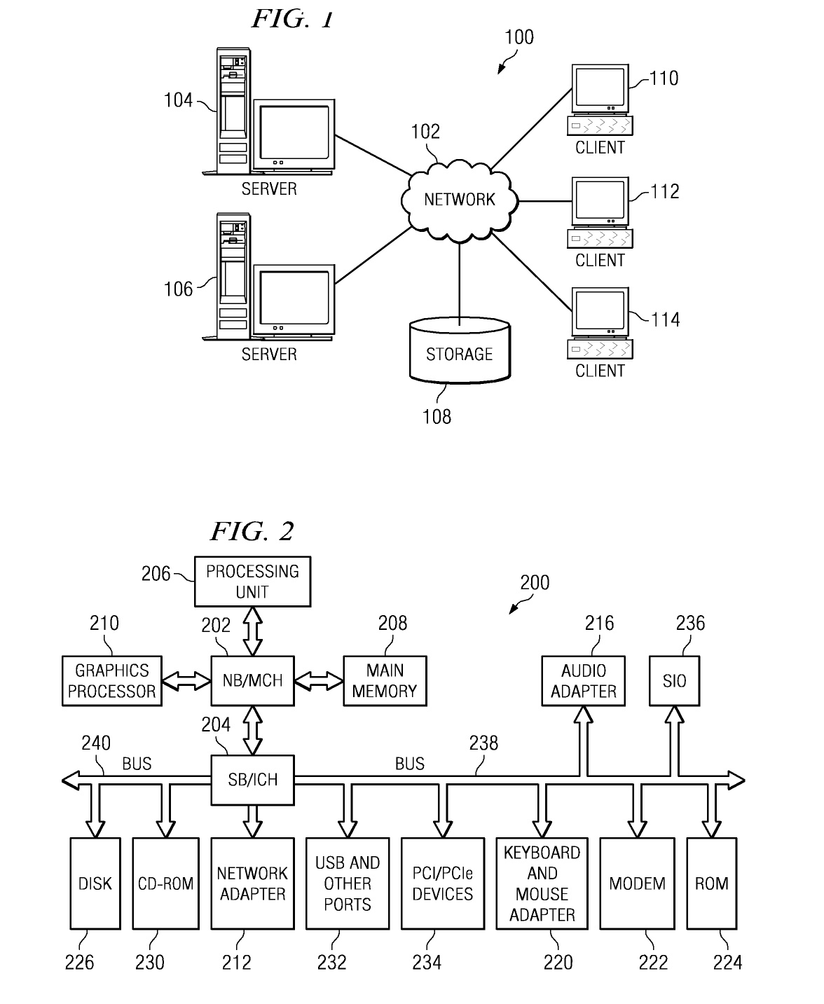

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

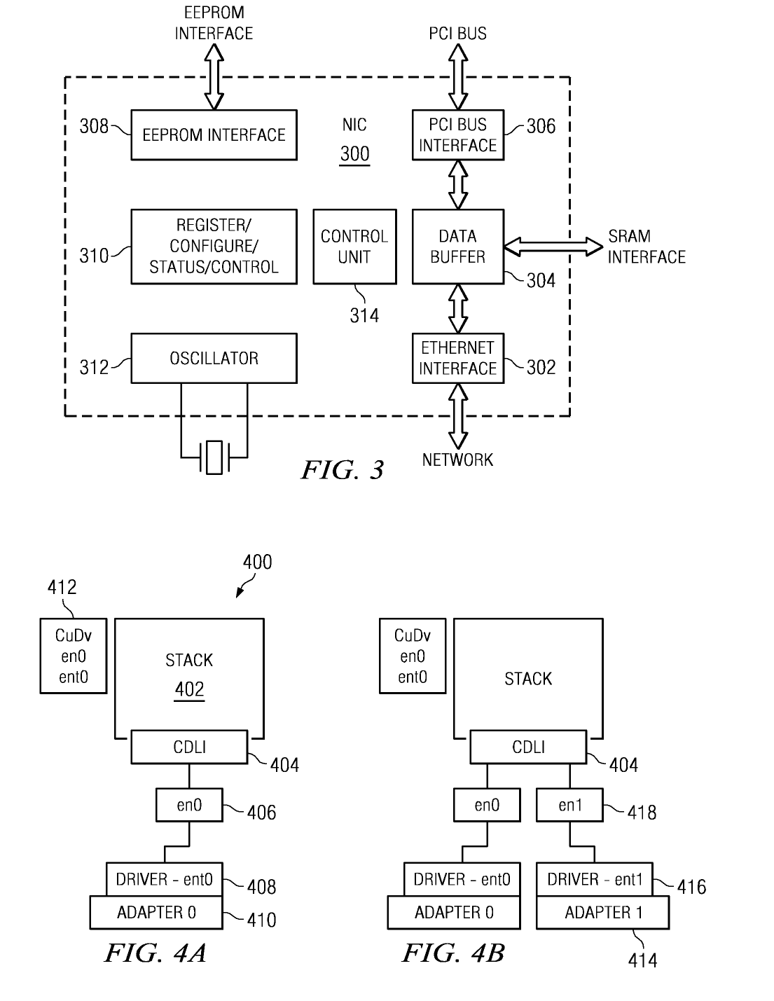

Turning now to FIG. 3, a diagram of a network adapter is depicted in accordance with the illustrative embodiments. Network adapter 300 may be implemented as network adapter 212 in FIG. 2. As shown, network adapter 300 includes Ethernet interface 302, data buffer 304, and PCI bus interface 306. These three components provide a path between the network and the bus of the data processing system. Ethernet interface 302 provides an interface to the network connected to the data processing system. PCI bus interface 306 provides an interface to a bus. Data buffer 304 is used to store data being transmitted and received through network adapter 300. This data buffer also includes a connection to a SRAM interface to provide for additional storage.

Network adapter 300 also includes electrically erasable programmable read-only memory (EEPROM) interface 308, register/configure/status/control unit 310, oscillator 312, and control unit 314. EEPROM interface 308 provides an interface to an EEPROM chip, which may contain instructions and other configuration information for network adapter 300. Different parameters and setting may be stored on an EEPROM chip through EEPROM interface 308.

Register/configure/status/control unit 310 provides a place to store information used to configure and run processes on network adapter 300. For example, a timer value for a timer may be stored within these registers. Additionally, status information for different processes also may be stored within this unit. Oscillator 312 provides a clock signal for executing processes on network adapter 300.

Control unit 314 controls the different processes and functions performed by network adapter 300. Control unit 314 may take various forms. For example, control unit 314 may be a processor or an application-specific integrated chip (ASIC). In these examples, the processes of the present invention used to manage flow control of data are executed by control unit 314. If implemented as a processor, the instructions for these processes may be stored in a chip accessed through EEPROM interface 308.

Data is received in receive operations through Ethernet interface 302. This data is stored in data buffer 304 for transfer onto the data processing system across PCI bus interface 306. For example, the data may be transferred onto a bus using a PCI local bus or via ICH 210 in FIG. 2.

The illustrative embodiments provide a mechanism for replacing a network adapter in a data processing system with minimal or no communications downtime. In particular, the mechanism described in the illustrative embodiments allows for unplanned and also uninterrupted replacement of network adapters using the Common Data Link Interface (CDLI). Common Data Link Interface is used by AIX® as the interface between network adapters and the AIX® stack and serves as a layer through which all adapter communications and interfaces to the host operating system occur. AIX® (Advanced Interactive executive) is a UNIX operating system and is a product of IBM® Corporation. The illustrative embodiments exploit the relationship between the Common Data Link Interface and the network adapters and AIX stack to create the necessary functionality to dynamically replace an adapter in a live system. This unplanned adapter replacement feature does not requiring any prior planning or setup, such as required by Etherchannel. As previously mentioned, Etherchannel requires planning and configuring multiple adapters under an Etherchannel Link Aggregation group at system deployment time in order to dynamically allocate and remove network adapters in a live system. Additionally, in contrast with existing manual adapter replacement methods, the unplanned adapter replacement feature in the illustrative embodiments effectively provides a means to replace network adapters with no user intervention and a reduced error window. In other words, the process steps in the illustrative embodiments may be implemented independently of user interaction, thereby eliminating operator (user) errors often encountered in the manual adapter replacement methods. It is also possible to encapsulate an upgrade to an improved network adapter using the unplanned adapter replacement feature without interfering with connectivity.

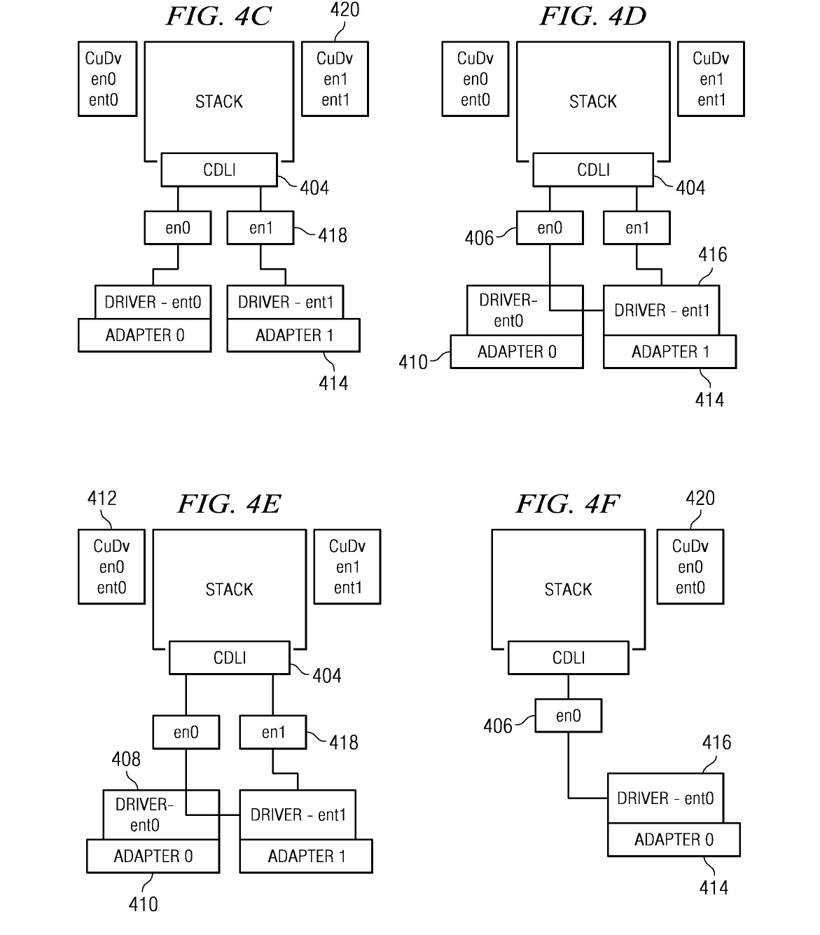

FIGS. 4A-4F are diagrams which illustrate a dynamic network adapter replacement operation in accordance with the illustrative embodiments. Replacement of a network adapter may be performed upon detecting that the adapter has failed in some way. Alternatively, the replacement operation may be performed to upgrade an adapter to a newer or different one. The replacement operation in this illustrative example comprises replacing a network adapter when an empty adapter slot is available to receive the new adapter. If an empty adapter slot is available, the replacement operation may be performed without a disruption in connectivity.

In FIG. 4A, data processing system 400 is shown to initially include stack 402, Common Data Link Interface 404, network interface (en0) 406, driver (ent0) 408, adapter 0 410, and device description entry 412. Stack 402 is an area in storage that stores temporary information, such as the values of local variables, for subprograms. A stack may be allocated by the operating system when a thread is created to process a task.

Common Data Link Interface 404 is an interface layer between stack 402 and adapter 0 410 and serves to encapsulate network adapter 0 410 from stack 402. All adapter communications and interfaces to the host operating system pass through Common Data Link Interface 404. Common Data Link Interface 404 is modified to enable the interface to be notified when the system administrator reallocates adapter resources in the data processing system.

Network interface (en0) 406 provides an interface layer between common data link interface 404 and adapter driver (ent0) 408. When a network adapter is physically installed on the data processing system, the operating system automatically adds the appropriate network interface for the adapter. In this particular instance, when adapter 0 410 was installed, the operating system assigned adapter 0 410 the name (ent0), and also added network interface (en0) 406 to the adapter. Consequently, stack 402 may only access adapter 0 410 via network interface (en0) 406.

Driver (ent0) 408 is a program which controls the communications between I/O device adapters and the processor adapter 0 410. Driver (ent0) 408 enables stack 402 to interact transparently with adapter 0 410 by providing commands to and/or receiving data from adapter 0 410. Driver (ent0) 408 translates functions calls from the stack into device specific calls.

Adapter 0 410 is a network adapter, such as network adapter 300 in FIG. 3. Adapter 0 410 is the adapter to be replaced in this example.

Device description entry 412 specifies configuration information of network adapter 0 410, and in particular, the physical dependencies of the adapter. In one embodiment, device description entry 412 may be a Custom Description (CuDv) object class file which contains customized system objects describing the network adapter's current configuration. In this example, device description entry 412 indicates that the physical dependencies of adapter 0 410 include en0 and ent0. Device description entry 412 may be managed by an Object Data Manager (ODM), which is a set of utilities employed by AIX® to manage configuration information. ODM may create, edit, and remove CuDv objects in a file.

As shown in FIG. 4B, when a system administrator determines that a network adapter should be replaced, the system administrator installs a new adapter, adapter 1 414, and, depending on what type of OS/options installation is performed, its corresponding driver (ent1) 416 if the driver is not already installed in the data processing system. Network interface (en1) 418 is also added to the system during installation of adapter 1 414. Adapter 1 414 is then connected to a network switch to create a connection to the network on the new adapter before the replacement operation can begin. The administrator initiates the adapter replacement operation by indicating to Common Data Link Interface 404 which adapters should be removed and replaced. The administrator may provide this indication via command line, Systems Management Interface Tool (SMIT)/WebSM, or a Hardware Management Console (HMC), for example.

In FIG. 4C, when Common Data Link Interface 404 receives notification of an adapter replacement, Common Data Link Interface 404 executes a configuration command to detect the new adapter (adapter 1 414) and the adapter's corresponding network interface (en1) 418. Once the adapter is detected, Common Data Link Interface 404 configures detected adapter 1 414 using existing configuration methods. In other words, no change to the existing methods of the data processing system for configuring the adapter is required. A new device description entry 420 is also created for the detected adapter. Device description entry 420 specifies that the physical dependencies of new adapter 1 414 in this illustrative example include en1 and ent1.

In FIG. 4D, Common Data Link Interface 404 pauses the communications over network interface (en0) 406 by dropping all incoming traffic over network interface (en0) 406 to adapter 0 410. However, these dropped data packets will be retransmitted to the replacement adapter via TCP. Since the en and ent interfaces are not interdependent, Common Data Link Interface 404 may then redirect network interface (en0) 406 to point to new adapter 1 414 via driver (ent1) 416.

In FIG. 4E, Common Data Link Interface 404 removes original adapter 0 410, the adapter's driver (ent0) 408, and network interface (en1) 418 from the data processing system.

Removal of adapter 0 410 in FIG. 4E also results in the removal of its corresponding device description entry 412 on the ODM, as illustrated in FIG. 4F. The ODM modifies device description entry 420 which specifies ent1 and en1 dependencies and changes the dependencies to ent0 and en0. Thus, device description entry 420 is changed to force ent1 to occupy the device description entry of ent0. Driver interface (ent1) 416 of replacement network adapter 1 414 is renamed as “ent0” to avoid confusion when running adapter specific commands, such as entstats.

Once the device description entry has been modified, the Media Access Control (MAC) address on the adapter is updated to reflect the adapter replacement. In one embodiment, the MAC address may be updated by overriding the unique MAC address assigned to the new adapter with the MAC address of the replaced adapter, thereby allowing the MAC address to remain the same for both adapters. Alternatively, the MAC address may be updated by broadcasting the new adapter's MAC address to the other devices in the network to reflect the adapter replacement. An Address Resolution Protocol (ARP) packet is transmitted to update the network switch. ARP broadcasts the MAC address assigned to the new adapter to other devices in the network. When the network switch is updated with the MAC address, the communication flow from the operating system or applications over network interface (en0) 406 to replacement network adapter 414 is restored and will continue in a normal manner.

While this particular example illustrates a replacement operation where there is an empty slot available to receive the replacement adapter, the illustrative embodiments also allow for replacing a network adapter when no empty slots are available. In this single adapter/slot replacement scenario, the existing adapter is first removed from its slot, and then the replacement adapter is inserted into that slot. Although this process results in a loss of connectivity for a short period of time, the replacement operation in the illustrative embodiments is still advantageous over existing adapter replacement methods based on reduced replacement time. The connectivity down time from when the adapter is physically removed in the single adapter/slot replacement scenario to the time the adapter is replaced may be consistent with the connectivity down time in the manual adapter replacement methods. However, the administrative time for removal and replacement may be decreased significantly using the illustrative embodiments. With the illustrative embodiments, the operator or administrator is not required to stop critical traffic, remove the interface, or close the adapter device driver. With existing adapter replacement methods, all of these steps are required to be performed manually, and use up a varying amount of time. Furthermore, the additional steps and user interaction required by the existing adapter replacement methods introduce the possibility of operator errors, in which case the replacement time would be increased exponentially. By implementing the process described in the illustrative embodiments, a user is only required to enter one or very few commands (implementation specific) to execute the same operations performed by the existing replacement methods, without having to stop critical traffic, remove the interface, or close the adapter device driver.

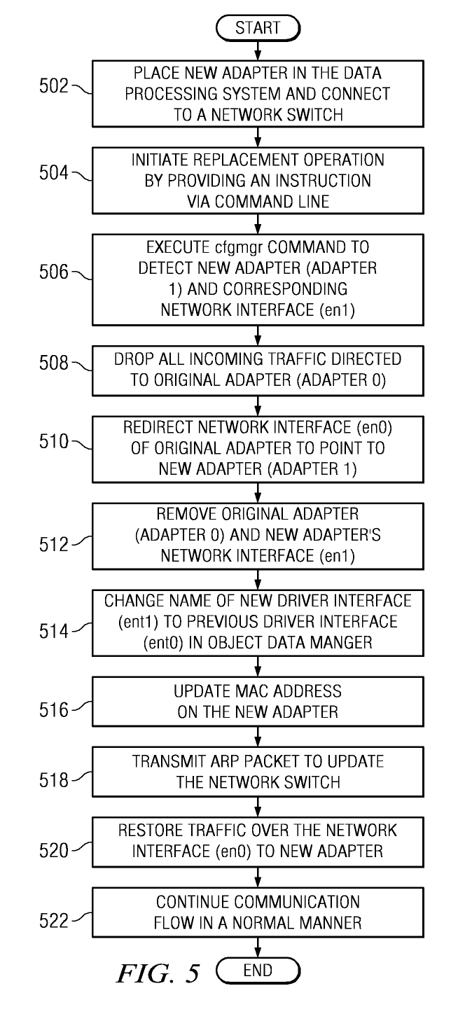

FIG. 5 is a flowchart of a process for implementing an unplanned replacement of a network adapter with minimal or no communications downtime in accordance with the illustrative embodiments. This process allows for performing an adapter replacement operation while encapsulating the operation from the stack and application. This process also allows for replacing a network adapter independently of user interaction, thus resulting in a reduced error window since no user intervention is required.

The process begins when a new adapter is placed in the data processing system and connected to a network switch (step 502). The replacement operation is then initiated by providing an instruction via command line, smit/WebSM, or HMC to the data processing system to remove a particular adapter and replace it with the new adapter (step 504).

The Command Data Link Interface executes a configuration command which detects the new adapter (adapter 1) and the new adapter's corresponding network interface (en1) (step 506). Upon detecting the new adapter, the Command Data Link Interface and the network interface (en0) drops all incoming traffic directed to the original adapter interface (e.g., adapter 0) (step 508). The network interface (en0) of the original adapter is redirected to point to the new adapter 1 via driver interface (ent1) (step 510).

The original adapter (adapter 0), its driver interface (ent0), and the new adapter's network interface (en1) are then removed (step 512). Removal of the adapter also removes the adapter device description entry on the object data manager. A change to the object data manager is performed to force the new driver interface (ent1) to occupy the device description entry of the previous driver interface ent0 (step 514).

The MAC address on the adapter is updated (step 516), and an ARP packet is transmitted to update the network switch (step 518). At this point, traffic over the network interface (en0) may be restored (step 520). The communication flow from the operating system or applications will continue in a normal manner (step 522), with the process terminating thereafter.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any-instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for dynamically replacing a network adapter in a data processing system, the computer implemented method comprising:
responsive to receiving a notification to replace a first network adapter, detecting a replacement network adapter and a network interface corresponding to the replacement network adapter;
configuring the replacement network adapter;
pausing communications to the first network adapter by dropping all incoming data packets to the first network adapter;
redirecting the network interface corresponding to the first network adapter to point to the replacement network adapter;
removing the first network adapter and the network interface corresponding to the replacement network adapter; and
restoring communication flow to the replacement network adapter;
wherein the detecting, configuring, pausing, redirecting, removing, and restoring steps are implemented independently of user interaction.

2. The computer implemented method of claim 1, wherein the detecting, configuring, pausing, redirecting, removing, and restoring steps are implemented using a common data link interface between the first network adapter and replacement network adapter and a stack, wherein the common data link interface encapsulates the first network adapter and replacement network adapter from the stack.

3. The computer implemented method of claim 1, wherein the replacement network adapter is installed in an empty adapter slot to allow the first network adapter to be replaced without a disruption in connectivity.

4. The computer implemented method of claim 1, wherein the notification is provided by a system administrator upon installation of the replacement network adapter in the data processing system.

5. The computer implemented method of claim 1, wherein the notification to replace the first network adapter is received in response to a failure of the first network adapter or in order to upgrade the first network adapter with the replacement network adapter.

6. The computer implemented method of claim 1, wherein detecting a replacement network adapter and a network interface corresponding to the replacement network adapter is implemented by executing a configuration command.

7. The computer implemented method of claim 1, wherein configuring the replacement network adapter further comprises:
creating a device description entry specifying the physical dependencies of the replacement network adapter.

8. The computer implemented method of claim 1, wherein removing the first network adapter further comprises:
renaming the replacement network adapter to a name of the first network adapter.

9. The computer implemented method of claim 1, wherein removing the first network adapter results in removal of a device description entry corresponding to the first network adapter.

10. The computer implemented method of claim 1, wherein restoring communication flow to the replacement network adapter further comprises:
updating a media access control address on the replacement network adapter with a media access control address of the first network adapter; and
transmitting an address resolution protocol packet to update a network switch in the data processing system.

11. The computer implemented method of claim 1, wherein restoring communication flow to the replacement network adapter further comprises:
retransmitting the dropped incoming data packets to the replacement network adapter.

12. A computer program product for dynamically replacing a network adapter in a data processing system, the computer program product comprising:
a computer usable medium having computer usable program code tangibly embodied thereon, the computer usable program code comprising:
computer usable program code for detecting, in response to receiving a notification to replace a first network adapter, a replacement network adapter and a network interface corresponding to the replacement network adapter;
computer usable program code for configuring the replacement network adapter;
computer usable program code for pausing communications to the first network adapter by dropping all incoming data packets to the first network adapter;
computer usable program code for redirecting the network interface corresponding to the first network adapter to point to the replacement network adapter;
computer usable program code for removing the first network adapter and the network interface corresponding to the replacement network adapter; and
computer usable program code for restoring communication flow to the replacement network adapter
wherein the computer usable program code for detecting, configuring, pausing, redirecting, removing, and restoring is executed independently of user interaction.

13. The computer program product of claim 12, wherein the replacement network adapter is installed in an empty adapter slot to allow the first network adapter to be replaced without a disruption in connectivity.

14. The computer program product of claim 12, wherein the notification to replace the first network adapter is received in response to a failure of the first network adapter or in order to upgrade the first network adapter with the replacement network adapter.

15. The computer program product of claim 12, wherein the computer usable program code for detecting a replacement network adapter and a network interface corresponding to the replacement network adapter is implemented by executing a configuration command.

16. The computer program product of claim 12, wherein the computer usable program code for configuring the replacement network adapter includes further comprises:
computer usable program code for creating a device description entry specifying the physical dependencies of the replacement network adapter.

17. The computer program product of claim 12, wherein the computer usable program code for removing the first network adapter further comprises:
computer usable program code for renaming the replacement network adapter to a name of the first network adapter.

18. The computer program product of claim 12, wherein removal of the first network adapter results in removal of a device description entry corresponding to the first network adapter.

19. The computer program product of claim 12, wherein the computer usable program code for restoring communication flow to the replacement network adapter further comprises:
computer usable program code for updating a media access control address on the replacement network adapter with a media access control address of the first network adapter; and
computer usable program code for transmitting an address resolution protocol packet to update a network switch in the data processing system.

20. A data processing system for dynamically replacing a network adapter, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to detect, in response to receiving a notification to replace a first network adapter, a replacement network adapter and a network interface corresponding to the replacement network adapter, configure the replacement network adapter, pause communications to the first network adapter by dropping all incoming data packets to the first network adapter, redirect the network interface corresponding to the first network adapter to point to the replacement network adapter, remove the first network adapter and the network interface corresponding to the replacement network adapter, and restore communication flow to the replacement network adapter, wherein the computer usable code to detect, configure, pause, redirect, remove, and restore is executed independently of user interaction.
